(19) United States
(12) Patent Application Publication
(10) Pub. No.: US 2010/0316335 A1
(43) Pub. Date: Dec. 16, 2010

(54) OPTOELECTRONIC INTERCONNECTION FILM, AND OPTOELECTRONIC INTERCONNECTION MODULE

(75) Inventor: Hideto Furuyama, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/729,299

(22) Filed: Mar. 23, 2010

(30) Foreign Application Priority Data
Jun. 15, 2009 (JP) 2009-142425

(51) Int. Cl. G02B 6/43

(52) U.S. Cl. 385/88

(57) ABSTRACT

According to an aspect of the present invention, there is provided an optoelectronic interconnection film: including an interconnection portion including: an optical waveguide core having at least two optical input/output portions; an optical waveguide cladding formed along the optical waveguide core; and an electrical wiring formed along the optical waveguide core; and a reinforcing substrate partially attached to the interconnection portion correspondingly with one of the optical input/output portions, wherein the interconnection portion includes: a rigid region to which the reinforcing substrate is attached; and a flexible region to which the reinforcing substrate is not attached, and wherein, in the flexible region, the optical waveguide core is arranged to not across a boundary between a region where the electrical wiring is provided and a region where the electrical wiring is not provided.

### CROSS-REFERENCE TO RELATED APPLICATIONS

This application claims priority from Japanese Patent Application No. 2009-142425 filed on Jun. 15, 2009, the entire contents of which are incorporated herein by reference.

### BACKGROUND

With an improvement in the performance of electronic devices, such as bipolar transistors or field-effect transistors, the operation speed of large-scale integration (LSI) circuits has increased significantly, which causes problems, such as limitations in the speed of electrical interconnects for connecting the circuits or operation errors due to electromagnetic noise. In order to solve the problems of the electric interconnects, some optical interconnect devices have been proposed which use light for signal transmission. For example, JP-2008-159766-A proposes an optoelectronic (OE) interconnection film in which optical (wiring) waveguides and electrical interconnects (such as power lines) are combined with each other.

### SUMMARY

According to an aspect of the present invention, there is provided an optoelectronic interconnection film: including an interconnection portion including: an optical waveguide core having at least two optical input/output portions; an optical waveguide cladding formed along the optical waveguide core; and an electrical wiring formed along the optical waveguide core; and a reinforcing substrate partially attached to the interconnection portion correspondingly with one of the optical input/output portions, wherein the interconnection portion includes: a rigid region to which the reinforcing substrate is attached; and a flexible region to which the reinforcing substrate is not attached, and wherein, in the flexible region, the optical waveguide core is arranged to not across a boundary between a region where the electrical wiring is provided and a region where the electrical wiring is not provided.

According to another aspect of the present invention, there is provided an optoelectronic interconnection module including: an interconnection portion including: an optical waveguide core having at least two optical input/output portions; an optical waveguide cladding formed along the optical waveguide core; and an electrical wiring formed along the optical waveguide core; a reinforcing substrate partially attached to the interconnection portion correspondingly with one of the optical input/output portions; and an optical semiconductor device connected to the electrical wiring while being optically coupled with the one of the optical input/output portions, wherein the interconnection portion includes: a rigid region to which the reinforcing substrate is attached; and a flexible region to which the reinforcing substrate is not attached, and wherein, in the flexible region, the optical waveguide core is arranged to not across a boundary between a region where the electrical wiring is provided and a region where the electrical wiring is not provided.

### BRIEF DESCRIPTION OF THE DRAWINGS

FIG. 1 is a perspective view illustrating an optoelectronic (OE) interconnection film according to a first embodiment.

FIG. 2 is a top view illustrating the OE interconnection film according to the first embodiment.

FIG. 3 is a cross-sectional view illustrating the OE interconnection film according to the first embodiment.

FIG. 4 is a top view illustrating the OE interconnection film according to the first embodiment.

FIGS. 5A to 5C illustrate an OE interconnection module according to a third embodiment, FIG. 5A illustrating a plan view, FIG. 5B illustrating a cross-sectional view taken along the line A-A of FIG. 5A, and FIG. 5C illustrating a cross-sectional view taken along the line B-B of FIG. 5A.

FIG. 6 is a cross-sectional view illustrating an OE interconnection module according to a modification of the third embodiment.

FIGS. 7A and 7B illustrate an OE interconnection module according to a fourth embodiment, FIG. 7A illustrating a plan view and FIG. 7B illustrating a cross-sectional view taken along the line C-C of FIG. 7A.

### DETAILED DESCRIPTION

Hereinafter, exemplary embodiments will be described with reference to the accompanying drawings. The following materials or structures are just illustrative, and any materials and structures having the same functions may be used. The invention is not limited to the following embodiments. In the following drawings, the same components are denoted by the same reference numerals. In the following description, one surface of an optoelectronic interconnection film on which optoelectronic conversion devices (such as light emitters and photo detectors) are mounted is defined as an upper surface.

In this embodiment, an optoelectronic (OE) interconnection film/module including optical interconnects (optical waveguides) and electrical interconnects integrally formed with each other is exemplified. That is, the optical interconnects and the electrical interconnects form one flexible printed circuit (FPC) board. The optical interconnects layers may be laminated on an electrical interconnects FPC. Alternatively, the electrical interconnects may be formed on one surface of the base film, such as a polyimide film, and the optical interconnect layers may be formed on the other surface of the base film.

In the OE interconnection film/module including optical interconnects and electrical interconnects integrally formed thereon, the mounting of optical semiconductor devices (for example, semiconductor laser diodes and photo diodes) and optical coupling thereof to the optical interconnects (optical waveguide cores) are achieved simultaneously with the electrical connection of the electrical interconnects. As a result, the structure is simplified and the number of parts and the number of assembly processes are reduced, thereby reducing manufacturing costs.

On the other hand, in the OE interconnection film/module including optical interconnects and electrical interconnects integrally formed thereon, the reliability of each of an electrical interconnect film and an optical interconnect film is reduced by the integration.

In contrast, in the related-art OE interconnection module of JP-2008-159766-A, the FPC having the electrical interconnects formed thereon, and the optical waveguide film, are individually manufactured and overlap each other. In such a pseudo optoelectronic composite interconnect structure, it may be necessary to mount and electrically connect the optical semiconductor devices (light-emitting and light-receiving devices) to the electrical wiring FPC, and optically couple optical input/output portions of the optical semiconductor devices to the optical waveguide. Therefore, a supporting base for fixing the electrical wiring FPC and the optical waveguide film is further needed, and the optical axes of the optical semiconductor devices and the optical waveguide should be adjusted after the optical semiconductor devices and the electrical wiring ETC are aligned with each other.

In the related art, the electrical wiring ETC is separated from the optical interconnection film having an optical waveguide. In this case, while the flexibility of each of the electrical wiring ETC and the optical interconnect film is maintained, the number of parts or assembly processes is increased, thereby increasing a material cost or an assembly cost and reducing manufacturing yield. In addition, since two FPCs are arranged in parallel to each other, as compared to when being formed into one ETC, a large space is needed in the cross-section direction for allowing the two interconnects to be flexibly twisted and bent.

In addition, since the electrical wiring FPC and the optical interconnects are bonded to each other with the supporting base interposed therebetween, the total thickness of the OE interconnection module is increased. Therefore, a mounting volume is increased and the reliability of the base adhesion portion is reduced.

### First Embodiment

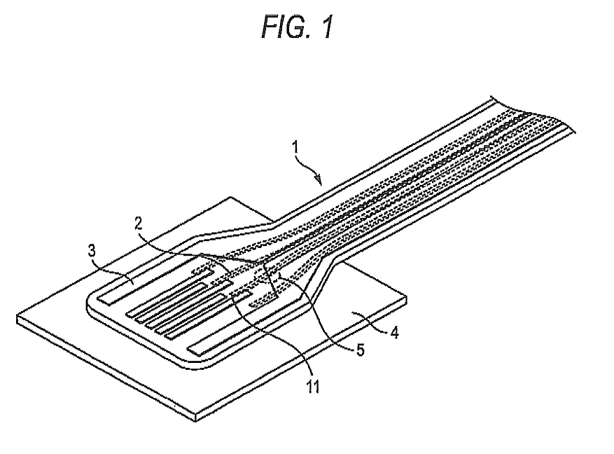

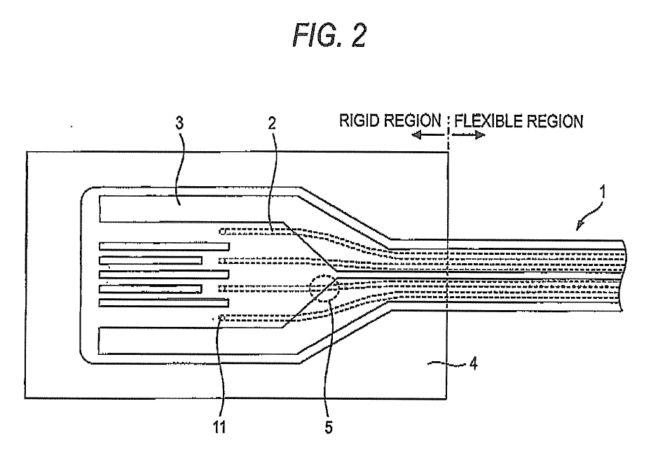

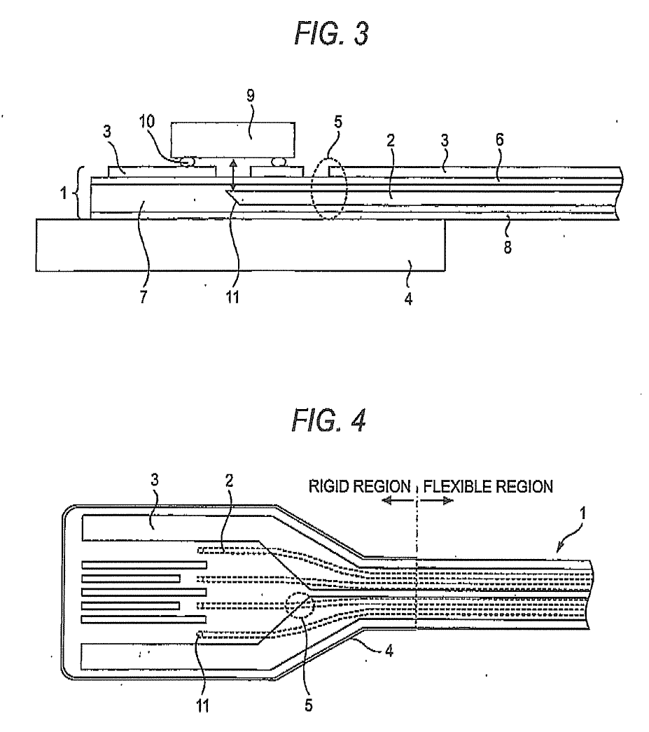

FIG. 1 is a perspective view illustrating an OE interconnection film according to a first embodiment, FIG. 2 is a top view illustrating the OE interconnection film shown in FIG. 1, and FIG. 3 is a side cross-sectional view illustrating an optical waveguide portion of the OE interconnection film shown in FIG. 1. In FIG. 3, an optical semiconductor device to be mounted on the OE interconnection film is also illustrated. In FIGS. 1 to 3, reference numeral 1 indicates an OE interconnection film, reference numeral 2 indicates an optical waveguide core (optical interconnect), reference numeral 3 indicates an electrical interconnect, reference numeral 4 indicates a reinforcing substrate, reference numeral 5 indicates an intersection of the optical waveguide core and the boundary (side surface) of the electrical interconnect (hereinafter, simply referred to as an “intersection”), reference numeral 6 indicates a base film made of, for example, polyimide, reference numeral 7 indicates an optical waveguide cladding (optical cladding), reference numeral B indicates a rear surface protective layer, reference numeral 9 indicates an optical semiconductor device (a light-emitting device or a light-receiving device) reference numeral 10 indicates bump metal (solder, Au, for example), reference numeral 11 indicates an optical input/output portion of the optical waveguide. In FIGS. 1 to 3, for example, a front surface protective layer (a coverlay and a solder resist) is omitted. However, it may be appropriately provided as necessary. The optical waveguide core 2 and the optical waveguide cladding 7 are made of resin materials with different refractive indexes. For example, the optical waveguide core 2 and the optical waveguide cladding 7 may be made of various kinds of materials, such as an epoxy resin, an acrylic resin, and a polyimide resin.

The reinforcing substrate 4 is a thick film (stiffener) that prevents an end region of the OE interconnection film 1 from being bent or twisted when the OE interconnection film 1 is bent or twisted. The reinforcing substrate 4 is attached to the rear surface of a rigid region of the OE interconnection film 1 including the optical input/output portion 11 and prevents the mechanical deformation of the rigid region. For example, a thick film or a laminated plate made of polyimide or epoxy, a resin plate including glass cloth, or a metal plate may be used as the reinforcing substrate 4.

In the OE interconnection film 1, an electrode for mounting a semiconductor chip, such as an optical device 9 and a driving IC therefor, can be formed. The semiconductor chip can be mounted onto the OE interconnection film 1 by, for example, the flip chip mounting using a bump metal 10, whereby the size of the module can be reduced. An optical input/output portion of the optical interconnect is positioned to not overlap with the electrical interconnect (electrode metal) so that the optical input/output portion directly faces to the optical device in a state where the optical device is mounted. Generally, the width of the electrical interconnect, such as a power supply line, formed in an intermediate portion of the OE interconnection film is maximized in order to reduce the electric resistance thereof or a variation in ground potential. As a result, in many cases, the optical waveguide is not overlapped with the electrical wiring metal in the end portion (optical input/output portion) of the OE interconnection film, while the optical waveguide overlaps the electrical wiring metal in the intermediate portion of the OE interconnection film. Therefore, in a portion of the OE interconnection film, as the intersection 5 in FIGS. 1 to 3, the optical waveguide intersects the boundary (side surface) of the electrical interconnect.

The inventor found that, when such “intersection” of the optical waveguide and a metal wiring is positioned in a middle of the OE interconnection film, the light propagation loss is gradually increased during a temperature cycle test or a film bending test. The reason is as follows. While the optical waveguide is made of a resin material, such as an epoxy resin, an acrylic resin, or a polyimide resin, the electrical wiring is a Cu film of several tens micrometers. Therefore, distortion caused by a thermal expansion difference due to a temperature variation and a mechanical extension/contraction is concentrated around the boundary (pattern end) of the Cu film, and a portion of the OE interconnection film around the boundary of the Cu film is locally deformed. As a result, the optical waveguide core provided below the deformed portion is also deformed, or cracked at worst, which results in an increase in light propagation loss.

In this embodiment, as shown in FIG. 2, the OE interconnection film is divided into a rigid region (fixed region) and a flexible region (bendable and twistable region). The rigid region is fixed to, for example, amounting substrate or whose rear surface is reinforced. The flexible region is formed to be bendable and twistable. The inventor found that such local deterioration can be prevented when the optical waveguide is arranged so as to intersect with the boundary of the electrical wiring metal in the rigid region and so as not to intersect therewith in the flexible region as shown in FIG. 2. This is because the local deformation around the boundary of the Cu film due to the distortion caused by temperature variation or mechanical deformation does not affect a region that is far away from the boundary of the Cu film.

Therefore, it is preferable to prevent the optical waveguide core from intersecting with the boundary of the electrical wiring metal, in order to prevent the partial deterioration of the optical waveguide core due to the local deformation around the boundary of the Cu film caused by the temperature variation or external force. And, when the optical waveguide core needs to intersect with the boundary of the electrical wiring metal, it is effective to provide a reinforcing substrate 4 in a region (rigid region) where the intersection 5 is located, as in this embodiment.

Since the deformation around the intersection of the boundary of the metal pattern and the optical waveguide core needs to be avoided, a reinforcement member may be provided only around the intersection (the rigid region may be partially provided). The inventor also found that it is effective to form the rigid region to be extended from the intersection by a distance corresponding to ten times the thickness of an OE interconnection film body (except for the reinforcement plate).

The rigid region may be provided in a middle of the flexible region of the OE interconnection film. That is, even when the intersection is disposed in a middle of the flexible region, the partial deterioration of the optical waveguide core therearound can be prevented by providing the reinforcing substrate 4 on the rear surface of the intersection, for example.

Practically, it is effective to space the optical waveguide core 2 from the boundary of the electrical wiring metal (such as a Cu film) by a distance equal to or more than two times the thickness of the electrical wiring metal. This is the same as in a case where the optical waveguide core is provided below the metal pattern and in a case where the optical waveguide core is provided in a portion in which the metal pattern is not provided.

Even though there is no intersection of the optical waveguide core and the boundary of the electrical wiring metal, if the electrical interconnect pattern has an intermittent portion in the flexible region (the intermittent portion traversing a longitudinal direction of the OE interconnection film), the entire OE interconnection film may be deformed so as to be bent at an acute angle. As a result, the propagation loss of light through the optical waveguide core may be increased, as in a case where the optical waveguide core intersects with the boundary of the electrical wiring metal in the flexible region.

Therefore, it is also preferable to not provide the intermittent portion in the electrical interconnect pattern within the flexible region. That is, regardless of whether the intersection is provided or not, it is preferable to from the electrical interconnect pattern so as not to have the intermittent portion, such as a discontinuous portion, with respect to the direction in which the optical waveguide extends (the longitudinal direction of the OE interconnection film).

The intermittent portion means a portion in which the electrical wiring metal or a marking metal pattern is cut and separated, but does not means the shape of the metal pattern. That is, it is preferable that the pattern of a metal thin film, such as an electrical interconnect, is not cut in the flexible region and is continuous between the rigid regions.

As shown in FIG. 1, the reinforcing substrate 4 may not be shaped to have the same contour as the OE interconnection film body (the OE interconnection film 1 except for the reinforcing substrate 4), and the reinforcing substrate 4 may be arbitrarily shaped as long as the mechanical deformation in the rigid region is suppressed sufficiently low during the bending and twisting in the flexible region. Of course, the reinforcing substrate 4 maybe shaped to have the same contour as the OE interconnection film body, as shown in FIG. 4.

In this embodiment, a portion (intersection) in which the boundary of the metal pattern and the optical waveguide core is prevented from being directly affected by the mechanical operation of the OE interconnection film, such as bending or twisting, or deformation due to a thermal expansion difference caused by temperature variation. The reinforcing substrate 4 (the rigid region including the reinforcing substrate 4) may be allowed to deform in a certain degree. The amount of deformation of the rigid region may be less than that of the flexible region.

### Second Embodiment

Through the temperature cycle test or the film repetitive bending test, in addition to not providing the intersection in a give region as in the first embodiment, it is also to be preferable that the optical waveguide core 2 is disposed below the electrical interconnect 3 in the flexible region as shown in FIG. 2, in order to prevent deterioration.

As shown in FIGS. 1 and 2, the optical input/output portion 11 for optical coupling is provided in a region in which the electrical interconnect 3 is not provided. The intersection 5 of the boundary of the electrical interconnect 3 and the optical waveguide core 2 is provided in the rigid region (for example, a light transmission side), the intersection 5 is not provided in the flexible region, and the intersection 5 is provided again in the opposite-side rigid region (for example, a light reception side) where the optical input/output portion is exposed.

In order to not provide the intersection in the flexible region, the optical waveguide core 2 may be provided to not be overlapped with the electrical interconnect 3 throughout the OE interconnection film. However, in this case, since stress or distortion occurring between the electrical interconnect metal and the film resin is transmitted through the surrounding resin, deterioration occurs slowly. Therefore, the above-mentioned structure using the metal film of the electrical interconnect 3 as a mechanical reinforcement member is effective to prevent the deterioration of the optical waveguide.

### Third Embodiment

Instead of using the reinforcing substrate 4, the rigid region may be formed by being attached to a mounting substrate (for example, a mounting board) to prevent mechanical deformation. That is, while the optoelectronic (OE) interconnect film itself does not have the rigid region, the rigid region may be provided in an optoelectronic (OE) interconnect module (which is an assembly including the OE interconnection film) by bonding and fixing a portion thereof corresponding to the rigid region to the mounting substrate, for example. In this case, the same effect as described above is obtained.

The portion corresponding to the rigid region can be fixed to the mounting board (for example, a general FR-4 substrate) by various fixing methods, such as a method of fixing the rear surface with an epoxy resin, a method of reversing the OE interconnection film such that an electrode surface faces a mounting board electrode and fixing the OE interconnection film while performing electrical connection with an anisotropic conductive resin, as described in detail below.

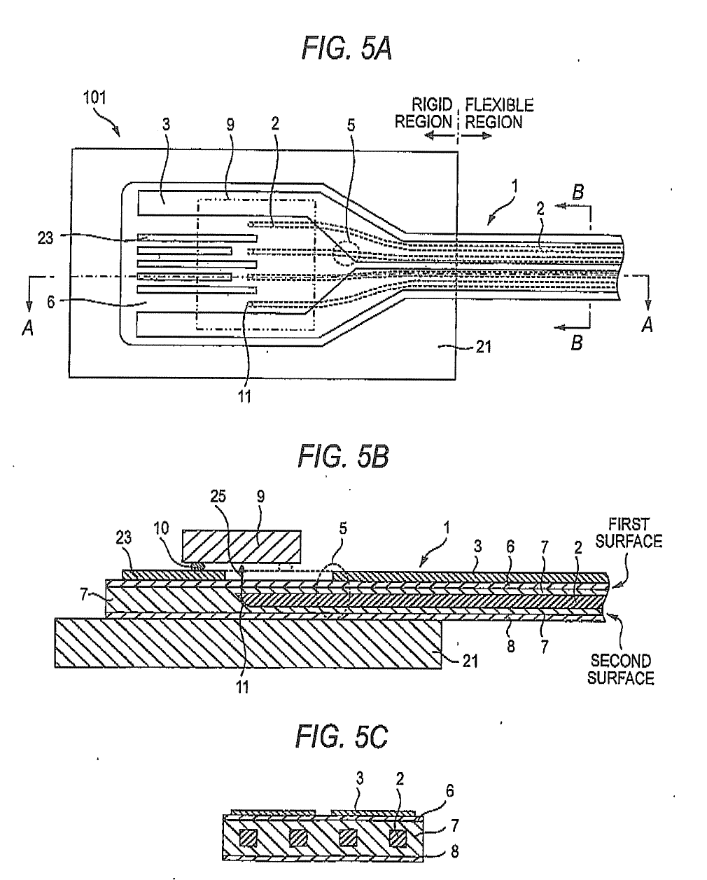

An OE interconnection module according to a third embodiment will be described with reference to FIGS. 5A to 5C.

As shown in FIGS. 5A to 5C, an OE interconnection module 101 includes: an OE interconnection film 1 including optical waveguide cores 2 each having an optical input/output portion 11, an optical waveguide cladding 7 which has rigid regions including the input/output portions 11 and a flexible region provided therebetween, has the optical waveguide cores 2 arranged therein, includes first and second surfaces opposite to each other, and has a rectangular cross section which is vertical to the longitudinal direction of the optical waveguide cores 2, electrical interconnects 3 that are fixed on the first surface, are provided in parallel to the optical waveguide cores 2 in the flexible region, and each have an intersection 5 of a side surface and at least a portion of the optical waveguide core 2 provided in the rigid region in a plan view, and electrical interconnects 23 that are fixed on the first surface and are provided in the rigid region so as to be electrically insulated from the electrical interconnects 3; an optical device 9 that is provided on the first surface, is optically coupled to the optical waveguide cores 2 in the rigid region, and is electrically connected to the electrical interconnects 23; and a mounting substrate 21 that is provided below the second surface and fixes the rigid region.

FIGS. 5A to 5C show one rigid region of the OE interconnection film 1 and a portion of the flexible region of the OE interconnection film 1 connected thereto, as a part of the OE interconnection module 101. One of the rigid regions serves as a light-emitting unit, and the other rigid region serves as a light receiving unit, but the two rigid regions (including the mounting substrates 21) have substantially the same structure.

FIGS. 5A to 5C show the light receiving unit side of the OE interconnection module 101. The optical device 9 is a light-receiving device. Emission light 25 travels from the optical waveguide core 2 to the optical device 9 as shown in FIG. 5B. Although not shown in FIG. 5B, in the OE interconnection module 101, a light-emitting device is provided in the other rigid region, and light traveling direction therein is an opposite.

As shown in FIGS. 5A and 5C, in the OE interconnection film 1, for example, four optical waveguide cores 2 are arranged in parallel to each other substantially in the same plane, and are covered with the optical waveguide cladding 7. The cross section of the optical waveguide core 7 in a direction vertical to the longitudinal direction has a rectangular shape or a chamfered rectangular shape (an elliptical-like shape), and may be made of a resin material, such as an epoxy resin, an acrylic resin, or a polyimide resin.

In the cross section vertical to the longitudinal direction, the width of the optical waveguide cladding 7 in a direction where the optical waveguide cores 2 are arranged in parallel to each other is large, and the width thereof in a direction vertical to the direction where the optical waveguide cores 2 are arranged in parallel to each other is small. That is, the optical waveguide cladding 7 has a transversely-elongated rectangular shape in which the width in the virtual plane where the optical waveguide cores 2 are arranged in parallel is larger than the width in a vertical direction thereto, and extends as a thin film or plate. The optical waveguide cladding 7 is made of a material with a refractive index less than that of the optical waveguide core 2. For example, the optical waveguide cladding 7 is made of a resin material, such as an epoxy resin, an acrylic resin, or a polyimide resin.

The width of the optical waveguide cladding 7 (in the direction in which the optical waveguide cores 2 are arranged in parallel) in the rigid region is larger than that in the flexible region. In the flexible region, in order to minimize an arrangement space, the width of the optical waveguide cladding 7 is made small. In the rigid region, for optical coupling between the optical waveguide cores 2 and the optical device 9 and electrical connection with the optical device 9, the gap between the optical waveguide cores 2 is increased. And, the width of the optical waveguide cladding 7 is also increased. In the rigid region, in order to increase the gap between the optical waveguide cores 2, each of the optical waveguide cores 2 is curved in the curvature range in which no light transmission error occurs.

A base film 6 is provided on the first surface (an upper surface in FIGS. 5B and 5C) of the optical waveguide cladding 7. The base film 6 is made of, for example, a polyimide resin, but it may be made of other resin materials.

A rear surface protective film 8 is provided on the second surface (a lower surface in FIGS. 5B and 5C) of the optical waveguide cladding 7. The rear surface protective film 8 is made of, for example, a polyimide resin, but it may be made of other resin materials.

As shown in FIG. 5A, the electrical interconnects 3 and 23 are provided on the base film 6. In the flexible region, the electrical interconnect 3 is substantially parallel to the optical waveguide core 2. The electrical interconnect 3 is, for example, a power line. In the flexible region, for example, two electrical interconnects 3 are arranged with the optical waveguide core 2 to be parallel therewith in the vertical direction while maintaining the allowed minimum distance therebetween.

In the rigid region of the OE interconnection film 1, for example, the gap between the electrical interconnects 3 is increased so that the electrical interconnects 3 are arranged at the ends of the rigid region in the width direction (the upper and lower sides of FIG. 5A). As the gap between the electrical interconnects 3 is increased, the electrical interconnects 3 are arranged at the further ends in the width direction while traversing on the optical waveguide cores 2. In a plan view, the side surface of the electrical interconnect 3 forms an intersection 5 with the optical waveguide core 2. The number of intersections 5 is equal to, for example, the number of optical waveguide cores 2.

The electrical interconnects 23 to be connected to the optical device 9 are provided on the optical waveguide cladding 7 opposite to the optical waveguide core 2. On the base film 6, the electrical interconnects 3 are arranged outside in the width direction, and the electrical interconnects 23 are arranged inside in the width direction. However, the arrangement is not limited thereto, and the other arrangement may be adapted. The electrical interconnects 3 and 23 are, for example, a Cu film. The electrical interconnects 3 and 23 may be made of an alloy having Cu as a main component, and a barrier metal may be added as necessary.

The OE interconnection film 1 includes a mounting substrate 21, the rear surface protective film 8, the optical waveguide cladding 7, the optical waveguide cores 2, the optical waveguide cladding 7, the base film 6, and the electrical interconnects 3 and 23 from the lower side of the second surface. A solder resist (not shown) may be provided on the base film 6 and the electrical interconnects 3 and 23. In the laminated state, the width of the OE interconnection film 1 in a direction vertical to the first surface is small (the thickness thereof is small). The OE interconnection film 1 is formed to be bendable to have curvature in the thickness direction, and forms a flexible interconnect substrate. The flexible region of the OE interconnection film 1 except for the rigid region is movable.

In the rigid region, the mounting substrate 21 is fixed to the rear surface protective film 8 below the second surface by an adhesive (not shown). The mounting substrate 21 is a thin plate, and has a sufficient thickness to fix the end of the OE interconnection film 1. The mounting substrate 21 is a glass epoxy substrate, but it may be made of a resin material, such as an epoxy resin, an acrylic resin, or a polyimide resin. When the mounting substrate 21 is made of an adhesive resin material, the adhesive may not be used. In stead of adhering a thin-plate member (the mounting substrate 21), resin may be adhered to be shaped into a plate, as a reinforcement member.

The mounting substrate 21 may serve as a circuit substrate, which is, for example, a glass epoxy substrate. The rigid region of the OE interconnection film 1 may be directly fixed to the circuit substrate or the mounting substrate by an adhesive (not shown).

As shown in FIG. 5A, the OE interconnection film 1 is arranged such that the intersection 5 is disposed inside the mounting substrate 21 in a plan view. The side surface of each of the electrical interconnects 3 traverses on two optical waveguide cores 2, thereby forming two intersections 5.

As shown in FIG. 5B, at the intersection 5, the optical waveguide cladding 7 and the base film 6 are arranged on the optical waveguide core 2. On the base film 6, with respect to the side surface of the electrical interconnect 3 as a boundary, the electrical interconnect 3 is disposed on the flexible region side, and a solder resist (not shown) is disposed on the opposite side. The term “traverse” means that the side surface of the electrical interconnect 3 is laid across both sides of the optical waveguide core 2 (the side surface of the electrical interconnect 3 is laid across one side surface and an inner portion of the optical waveguide core 2.

The optical input/output portion 11 of the optical waveguide core 2 has a reflecting surface that is inclined to reflect light passing through the optical waveguide core 2 to the optical device 9. For example, to acquire the emission light 25 vertical to the first surface, the reflecting surface of the optical input/output portion 11 is inclined at an angle of 45 degrees with respect to the first surface. However, the inclination angle is not limited to 45 degrees, but an appropriate angle may be used in accordance with the positional relationship between the optical device 9 and the optical input/output portion 11. For example, on the reflecting surface, a reflecting film made of a dielectric material or metal for facilitating light reflection may be provided.

The optical device 9 is fixed by, for example, bump electrodes 10 so as to be electrically connected to the electrical interconnects 3 and 23 and optically coupled to the optical waveguide cores 2. The gap between the optical device 9 and the OE interconnection film 1 may be filled up with, for example, an underfill (not shown) in order to increase adhesion therebetween.

Although not shown in the drawings, the electrical interconnects 3 and 23 are connected to electrical interconnects provided on the mounting substrate 21 by, for example, thin metal wires. For example, the mounting substrate 21 may be fixed to a wiring substrate having electrical interconnects different from the mounting substrate 21, and the electrical interconnects 3 and 23 may be electrically connected to the wiring substrate.

As described above, the OE interconnection module 101 includes: the OE interconnection film 1 including the optical waveguide cores 2, the plate-shaped optical waveguide cladding 7 which covers the optical waveguide cores 2, the electrical interconnects 3 that are fixed on the first surface and have the intersections 5 of the side surfaces of the electrical interconnects 3 and the optical waveguide cores 2 in the rigid region in a plan view, and the electrical interconnects 23 that are fixed on the first surface; the optical device 9 that is provided on the first surface, is optically coupled to the optical waveguide cores 2, and is electrically connected to the electrical interconnects 23 in the rigid region; and the mounting substrate 21 that is provided below the second surface and fixes the rigid region.

In the rigid region, the OE interconnection film 1 is fixed by the mounting substrate 21 so as not to be flexible. On the other hand, in the flexible region in which the mounting substrate 21 is not provided, the OE interconnection film 1 moves flexibly. Since the intersection 5 is fixed by the mounting substrate 21, the influence of local deformation occurring around the intersection 5 of the side surface of the electrical interconnect 3 and the optical waveguide core 2 can be prevented. That is, the bending/twisting force occurring when a portion around the intersection is flexibly moved on the waveguide core is prevented in the OE interconnection module 101. Since such force is not applied, an increase in propagation loss due to the deformation and damage of the optical waveguide core 2 is prevented in the OE interconnection module 101, and the OE interconnection module 101 can be stably used for a long time.

In the flexible region, the optical waveguide cores 2 and the electrical interconnects 3 are laminated so as to interpose the optical waveguide cladding 7 and the base film 6 therebetween while extending in the longitudinal direction. In the flexible region, the OE interconnection film 1 is made to have a small cross-sectional area so as to be flexible. As a result, the optical waveguide cores 2 are mechanically reinforced by the electrical interconnects 3, as compared to the structure in which the electrical interconnects 3 and the optical waveguide cladding 7 are individually provided without being fixed. Therefore, propagation loss due to partial deterioration of the intersection 5 is prevented for a long time, and the OE interconnection module 101 can be stably used for a long time.

For example, the following modification can be made. The modification differs from the third embodiment in that the OE interconnection film has via plugs that pass through the upper and lower surfaces thereof. In the modification, the same components as those in the third embodiment are denoted by the same reference numerals, and a description thereof will be omitted. Components different from those in the third embodiment will be described.

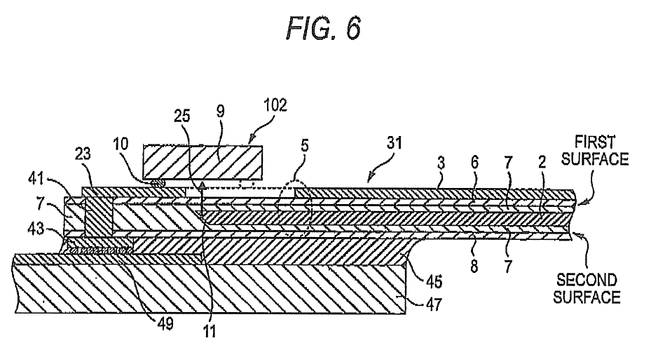

As shown in FIG. 6, in an OE interconnection module 102, an OE interconnection film 31 includes the electrical interconnect 23 on the first surface, a rear surface electrode 43 provided below the second surface, and via plugs 41 connected to the electrical interconnect 23 and the rear surface electrode 43. In the OE interconnection module 102, a mounting substrate 47 includes a substrate electrode 49 on a surface facing the rear surface electrode 43. The rear surface electrode 43 and the substrate electrode 49 are connected to each other by, for example, an anisotropic conductive resin 45.

The rear surface electrode 43 and the substrate electrode 49 are made of the same material as those used to form the electrical interconnects 3 and 23. The mounting substrate 47 made of the same material as that used to form the mounting substrate 21 according to the third embodiment. The anisotropic conductive resin 45 is formed by mixing gold/nickel-plated particles in a thermosetting resin, such as an epoxy resin. A portion corresponding to the intersection 5 is fixed on the mounting substrate 47 by the anisotropic conductive resin 45. The gap between the OE interconnection film 31 and the mounting substrate 47 is larger than that in the third embodiment, but the fixing strength therebetween is substantially equal to that in the third embodiment.

As a result, the OE interconnection module 102 has the same effects as the OE interconnection module 101 according to the third embodiment. Further, since the OE interconnection film 31 and the mounting substrate 47 are fixed with each other while being electrically connected at the same time, a manufacturing process can be simplified.

By appropriately using via plugs (as the via plugs 41), the positions of the optical device 9 and the mounting substrate 47 can be reversed.

### Fourth Embodiment

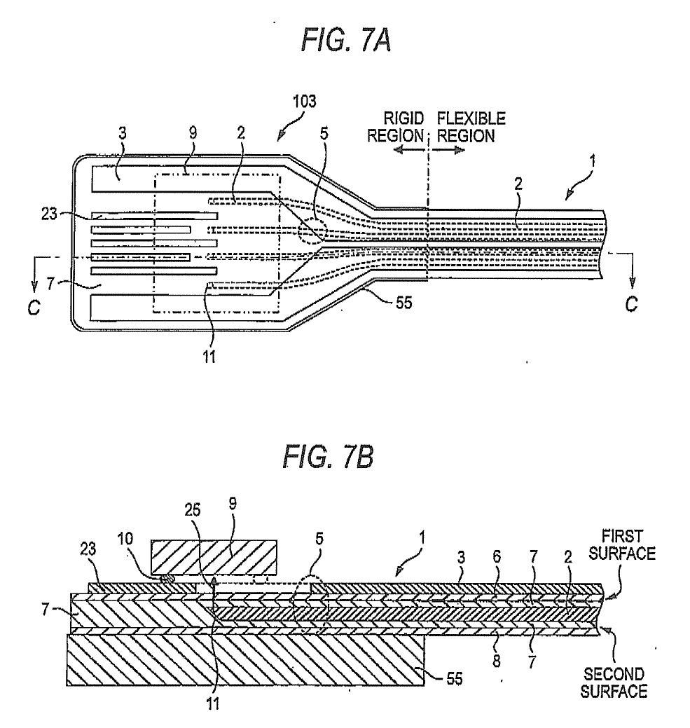

An optoelectronic (QE) interconnect module according to a fourth embodiment will be described with reference to FIGS. 7A and 7B. The fourth embodiment differs from the third embodiment in that the mounting substrate has substantially the same shape as the optoelectronic (OE) interconnect film that is provided above the rear surface protective film in a plan view. In the fourth embodiment, the same components as those in the third embodiment are denoted by the same reference numerals, and a description thereof will be omitted. Components different from those in the third embodiment will be described.

As shown in FIG. 7A, in an OE interconnection module 103, a reinforcing substrate 55 is formed so that a side surface thereof overlaps with the side surface of the OE interconnection film 1 (side surfaces of the base film 6, the optical waveguide cladding 7 and the rear surface protective film 8) or slightly extends outward beyond the side surface of the OE interconnection film 1. That is, in a plan view, the reinforcing substrate 55 is disposed below the OE interconnection film 1 so as to be substantially concealed therefrom, and the intersection 5 is disposed inside the reinforcing substrate 55.

Similar to the OE interconnection module 101 according to the third embodiment, the OE interconnection module 103 can be fixed on the wiring substrate having the electrical interconnects. In this case, similar to the OE interconnection module 102 according to the modification of the third embodiment, the OE interconnection module 103 may have via plugs.

Although not shown in the drawings, a portion (a left portion of FIGS. 7A and 7B) of the electrical interconnect 23 opposite to the flexible region of the OE interconnection module 103 may be a male connector, and the male connector may be connected to a female connector having a connection portion that can be electrically connected to the electrical interconnects 3 and 23. The OE interconnection module 103 may be detachable from the female connector, and the OE interconnection module 103 and the female connector may be connected and fixed. For example, the female connector may be fixed to the mounting substrate, or may be connected to a flexible interconnect.

As a result, the OE interconnection module 103 has the same effects as the OE interconnection module 101 according to the third embodiment. Therefore, the OE interconnection module 103 can be electrically connected by various connection methods, and the applicability thereof can be increased.

The invention is not limited to the above-described embodiments, but various modifications and changes of the invention can be made without departing from the scope and spirit of the invention.

For example, in the above-described embodiments, four optical waveguide cores and two electrical interconnects are provided in the flexible region. However, the invention can be applied to an OE interconnection module having one or more optical waveguide cores and one or more electrical interconnects in the flexible region.

In the above-described embodiments, the optical waveguide cores are arranged in parallel to each other to form one (imaginary) plane, and the electrical interconnects are arranged in parallel to each other in a plane that is parallel to the plane formed by the optical waveguide cores. However, the optical waveguide cores may be arranged in parallel to each other on a plane including a plurality of layers, and the electrical interconnects may be arranged in parallel to each other on a plane including a plurality of layers that is parallel to the plane formed by the optical waveguide cores.

The present invention is not limited to the above-described embodiments. And, various modifications can be made without departing from the spirit of the present invention. For example, the materials, structures, shapes, substrates, and processes exemplified in the embodiments are merely examples. Another material, structure, shape, substrate, and process differing from those exemplified in the embodiments can be used as necessary.

What is claimed is:

1. An optoelectronic interconnection film comprising:
an interconnection portion including:
an optical waveguide core having at least two optical input/output portions;
an optical waveguide cladding formed along the optical waveguide core; and
an electrical wiring formed along the optical waveguide core; and
a reinforcing substrate partially attached to the interconnection portion correspondingly with one of the optical input/output portions,
wherein the interconnection portion includes:
a rigid region to which the reinforcing substrate is attached; and
a flexible region to which the reinforcing substrate is not attached, and
wherein, in the flexible region, the optical waveguide core is arranged to not across a boundary between a region where the electrical wiring is provided and a region where the electrical wiring is not provided.

2. The film of claim 1,
wherein the electrical wiring includes:
an extending portion that is provided in the flexible region and that extends along the optical waveguide core;
an end portion that is provided on the rigid region; and
a connection portion that connects the extending portion and the end portion.

3. The film of claim 2,
wherein, as viewed from above, the extending portion overlaps with the optical wave guide core,
wherein, as viewed from above, the end portion does not overlap with the optical waveguide core, and
wherein, as viewed from above, the connection portion intersects with the optical waveguide core only within the rigid region.

4. The film of claim 2,
wherein, as viewed from above, the extending portion does not overlap with the optical wave guide core,
wherein, as viewed from above, the end portion does not overlap with the optical waveguide core, and
wherein, as viewed from above, the connection portion does not intersect with the optical waveguide core.

5. The film of claim 1,
wherein, in the flexible region, the electrical wiring is formed so as not to be intermittent along an extending direction of the interconnection portion.

6. The film of claim 1,
wherein, in the flexible region, the electrical wiring and the optical waveguide core are arranged so as to overlap with each other.

7. The film of claim 1,
wherein the interconnection portion includes an optical input/output surface where the one of the optical input/output portions is provided, and
wherein the reinforcing substrate is attached to the other surface of the interconnection portion than the optical input/output surface.

8. The film of claim 1,
wherein a plurality of optical waveguide cores are provided, and
wherein a space between the optical waveguide cores around the optical input/output portion is larger than a space between the optical waveguide cores in the flexible region.

9. The film of claim 1,
wherein, as viewed from above, the reinforcing substrate has a contour substantially the same with a contour of the interconnection portion in the rigid region.

10. The film of claim 1,
wherein the optical input/output portion has a mirror angled about 45 degrees relative to an extending direction of the interconnection portion.

11. The film of claim 1,
wherein, in the rigid region, the electrical wiring is formed to allow an optical device to be mounted thereon so that the optical device is optically coupled with the optical input/output portion.

12. The film of claim 11,
wherein the electrical wiring includes a power line.

13. An optoelectronic interconnection module comprising:
an interconnection portion including:
an optical waveguide core having at least two optical input/output portions;
an optical waveguide cladding formed along the optical waveguide core; and
an electrical wiring formed along the optical waveguide core;
a reinforcing substrate partially attached to the interconnection portion correspondingly with one of the optical input/output portions; and
an optical semiconductor device connected to the electrical wiring while being optically coupled with the one of the optical input/output portions,
wherein the interconnection portion includes:
a rigid region to which the reinforcing substrate is attached; and
a flexible region to which the reinforcing substrate is not attached, and
wherein, in the flexible region, the optical waveguide core is arranged to not across a boundary between a region where the electrical wiring is provided and a region where the electrical wiring is not provided.

14. The module of claim 13,
wherein, in the flexible region, the electrical wiring is formed so as not to be intermittent along an extending direction of the interconnection portion.

15. The module of claim 13,
wherein, in the flexible region, the electrical wiring and the optical waveguide core are arranged so as to overlap with each other.

16. The module of claim 13,
wherein, in the flexible region, the electrical wiring and the optical waveguide core are arranged so as not to overlap with each other.

17. The film of claim 13,
wherein the interconnection portion includes an optical input/output surface where the one of the optical input/output portions is provided, and
wherein the reinforcing substrate is attached to the other surface of the interconnection portion than the optical input/output surface.

18. The module of claim 13,
wherein the reinforcing substrate includes a mounting substrate.

19. The module of claim 13,
wherein the optical input/output portion has a mirror angled about 45 degrees relative to an extending direction of the interconnection portion.

20. The module of claim 13,
wherein the electrical wiring includes a power line.
